(19) United States
(12) Patent Application Publication
(10) Pub. No.: US 2025/0273731 A1
(43) Pub. Date: Aug. 28, 2025

(54) LITHIUM ION SECONDARY BATTERY AND MANUFACTURING METHOD THEREOF

(71) Applicant: NAIEEL TECHNOLOGY, INC., Daejeon (KR)

(72) Inventors: Jae Woo KIM, Daejeon (KR); Jung Hwan JUNG, Daejeon (KR); Numan YANAR, Daejeon (KR); You Seok KIM, Daejeon (KR); Nam Gyeong KIM, Daejeon (KR)

(73) Assignee: NAIEEL TECHNOLOGY, INC., Daejeon (KR)

(21) Appl. No.: 18/649,042

(22) Filed: Apr. 29, 2024

(30) Foreign Application Priority Data
Feb. 22, 2024 (KR) 10-2024-0025979

(51) Int. Cl. H01M 10/0525; H01M 50/403; H01M 50/434; H01M 50/449; H01M 50/497

(52) U.S. Cl. CPC H01M 10/0525; H01M 50/403; H01M 50/434; H01M 50/449; H01M 50/497

(57) ABSTRACT

Provided is a lithium ion secondary battery including an electrode assembly including an anode, a cathode, and a separator disposed between the anode and the cathode, a case accommodating the electrode assembly, and an electrolyte filling the case, wherein the separator includes a coating layer on at least one of both sides of the separator, and the coating layer includes boron nitride nanotubes.

### CROSS-REFERENCE TO RELATED APPLICATION

This application claims the benefit of Korean Patent Application No. 10-2024-0025979, filed on Feb. 22, 2024, in the Korean Intellectual Property Office, the disclosure of which is incorporated herein in its entirety by reference.

### BACKGROUND

### 1. Field

The present disclosure relates to lithium ion secondary batteries and methods for manufacturing the same.

### 2. Description of the Related Art

Unlike disposable batteries that are discarded after use, secondary batteries are batteries that can be reused through repeated charging and discharging. They are used in various fields such as mobile phones, laptops, and electric vehicles, and have recently been increasingly used as energy storage devices.

There are various types of secondary batteries, and a representative example is a lithium-ion secondary battery. Lithium-ion secondary batteries have high energy density, relatively short charging time due to no memory effect, and easy charging and discharging. Meanwhile, the charge/discharge efficiency and charging time of lithium ion secondary batteries are affected by the ionic conductivity of lithium ions. Therefore, there is a need to improve the ionic conductivity of lithium ions to improve the efficiency of lithium ion secondary batteries.

### SUMMARY

Embodiments of the present disclosure provide a lithium ion secondary battery with improved ionic conductivity and a method of manufacturing the same.

Additional aspects will be set forth in part in the description which follows and, in part, will be apparent from the description, or may be learned by practice of the presented embodiments.

An embodiment of the present disclosure provides a lithium ion secondary battery including an electrode assembly including an anode, a cathode, and a separator disposed between the anode and the cathode, a case accommodating the electrode assembly; and an electrolyte filling the case, wherein the separator includes a coating layer on at least one of both sides of the separator, and the coating layer includes boron nitride nanotubes.

In an embodiment, the ionic conductivity of the separator may be 1.7 mS/cm or less at 60° C., and 0.4 mS/cm or more at −10° C.

In an embodiment, the average surface roughness of the coating layer may be about 50 nm to about 2 μm.

In an embodiment, the aspect ratio of the boron nitride nanotubes may be about 20 to about 6000.

In an embodiment, the boron nitride nanotubes may be surface-treated to have hydrophilicity or hydrophobicity.

In an embodiment, the surface-treated boron nitride nanotubes may further include a first layer located on at least a portion of the boron nitride nanotubes, and the first layer includes a hydroxy phenyl group and may form a π bond with boron nitride nanotubes.

In an embodiment, the surface-treated boron nitride nanotubes may have the hydrophilic property.

In an embodiment, the surface-treated boron nitride nanotubes may further include a second layer on the first layer, and the second layer includes an amine group or a thiol group as a hydrocarbon group, and the surface-treated boron nitride nanotubes may have the hydrophobicity.

In an embodiment, at least some of the boron nitride nanotubes may be attached to the surface of the separator at an angle of about 1° to about 30°.

Another embodiment of the present disclosure provides a method of manufacturing a lithium ion secondary battery, the method including mixing boron nitride nanotubes with a solvent to form a coating solution, forming a coating layer by coating at least one of both sides of the separator with the coating solution, placing an anode and a cathode respectively on both sides of the separator on which the coating layer is formed, to form an electrode assembly, and placing the electrode assembly in a case and filling the case with an electrolyte.

In an embodiment, the coating layer may be formed by coating at least one of both sides of the separator with the coating solution via electrostatic spraying or mechanical spraying.

In an embodiment, after forming the coating layer, the method may further include drying the coating layer.

In an embodiment, the coating solution may include about 0.01 wt % to about 10 wt % of the boron nitride nanotubes.

In an embodiment, the boron nitride nanotubes may be surface-treated to have hydrophilicity or hydrophobicity.

In an embodiment, the average surface roughness of the coating layer may be about 50 nm to about 2 μm.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view schematically showing an example of a lithium ion secondary battery according to an embodiment of the present disclosure;

FIG. 2 is a transmission electron microscopy (TEM) image of boron nitride nanotubes included in a coating layer of FIG. 1;

FIG. 3 is a scanning electron microscope (SEM) image of the surface of a separator on which the coating layer of FIG. 1 is formed;

FIG. 4 is a flowchart schematically showing the manufacturing method of the lithium ion secondary battery of FIG. 1;

FIG. 5 is a perspective view schematically showing an example of boron nitride nanotubes included in the coating layer of FIG. 1;

FIG. 6 is a flowchart schematically showing the surface treatment method of the boron nitride nanotube of FIG. 5;

FIG. 7 is a perspective view schematically showing an example of boron nitride nanotubes included in the coating layer of FIG. 1;

FIG. 8 is a flowchart schematically showing the surface treatment method of the boron nitride nanotube of FIG. 7;

FIG. 9 is a diagram schematically showing an example of a method of forming a boron nitride nanotube coating layer on the separator of FIG. 1;

FIG. 10 is a diagram showing the results of measuring the lithium ionic conductivity of the separator.

FIG. 11 is a graph showing the results of measuring the initial charge and discharging capacity of a lithium ion secondary battery;

FIGS. 12 and 13 show the rate performance of a lithium ion secondary battery according to temperature and charge/discharge speed;

FIGS. 14 and 15 show the results of measuring the temperature of a lithium ion secondary battery during charging and discharging;

FIGS. 16 and 17 are graphs showing cyclic voltammetry (CV) test results of a lithium ion secondary battery;

FIG. 18 is a diagram showing the characteristics (C-rate performance) according to the charge and discharge rate of a lithium ion secondary battery; and

FIG. 19 is a diagram showing the cycle retention results of the lithium ion secondary battery of FIG. 18.

### DETAILED DESCRIPTION

The present disclosure may be modified in various ways and may have various embodiments. Accordingly, specific embodiments will be illustrated in the drawings and described in detail in the detailed description. The effects and features of the present disclosure and methods for achieving the same will become clear by referring to the embodiments described in detail below along with the drawings. However, the present disclosure is not limited to the embodiments disclosed below and may be implemented in various forms.

In the following embodiments, terms such as first and second are used not in a limiting sense but for the purpose of distinguishing one component from another component.

In the following embodiments, singular terms include plural terms unless the context clearly dictates otherwise.

In the following embodiments, terms “include” or “comprise” refer to that the features or components described in the specification exist, and do not exclude in advance the possibility of adding one or more other features or components.

In the following embodiments, when a part, for example, a film, region, component, etc. is said to be on or on another part, it is not only the case where it is directly on the other part, but also the case where another film, region, component, etc. is located therebetween.

In the drawings, the sizes of components may be exaggerated or reduced for convenience of explanation. For example, the size and thickness of each component shown in the drawings are shown arbitrarily for convenience of explanation. Accordingly, the present disclosure is not necessarily limited to what is shown.

Hereinafter, embodiments of the present disclosure will be described in detail with reference to the accompanying drawings, and when described with reference to the drawings, identical or corresponding components will be assigned with the same reference numerals.

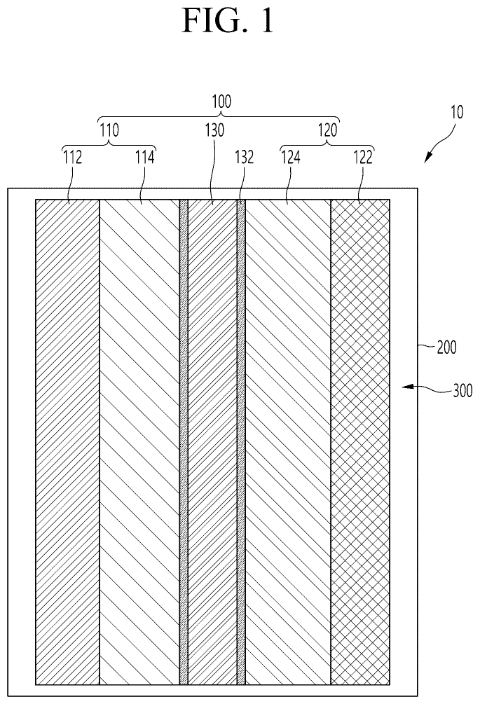

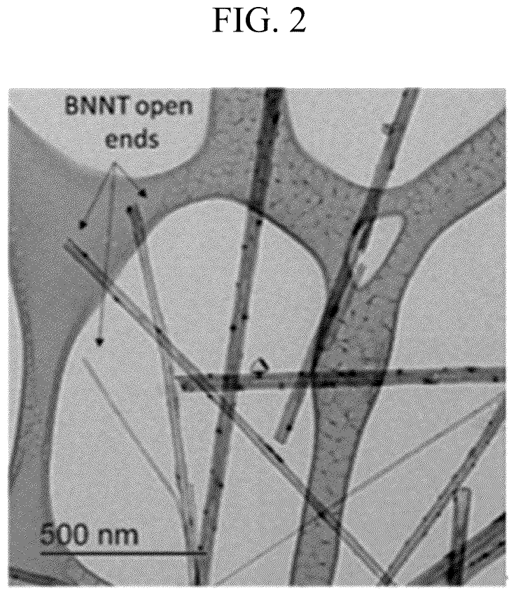

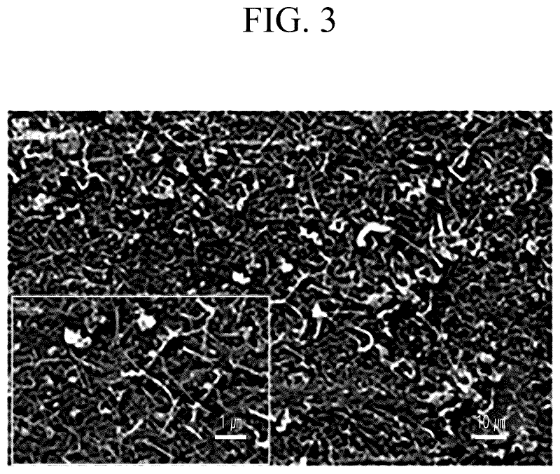

FIG. 1 is a cross-sectional view schematically showing an example of a lithium ion secondary battery 10 according to an embodiment of the present disclosure, FIG. 2 is a transmission electron microscopy (TEM) image of boron nitride nanotubes included in a coating layer of FIG. 1, and FIG. 3 is a scanning electron microscope (SEM) image of the surface of a separator on which the coating layer of FIG. 1 is formed.

Referring to FIG. 1, a lithium ion secondary battery 10 according to an embodiment of the present disclosure includes an electrode assembly 100, a case 200 for housing the electrode assembly, and an electrolyte 300 filling in the case 200.

The electrode assembly 100 may include a cathode 110, an anode 120, and a separator 130 disposed therebetween to prevent short circuit between the cathode 110 and the anode 120.

The cathode 110 may include a cathode film 112 and a cathode active material layer 114 applied on the cathode film 112. Although FIG. 1 shows that the cathode active material layer 114 is applied to one side of the cathode film 112, the present disclosure is not limited to this and the cathode active material layer 114 may be applied to both sides of the cathode film 112.

The cathode film 112 may include a metal formed of aluminum, stainless steel, titanium, silver, or a combination thereof.

The cathode active material layer 114 may include a cathode active material, a binder, and a conductive agent.

The cathode active material may include a material that can reversibly store and release lithium ions. For example, the cathode active material may include at least one material selected from the group consisting of lithium transition metal oxides such as lithium cobaltate, lithium nickelate, lithium nickel cobaltate, lithium nickel cobalt aluminate, lithium nickel cobalt manganate, lithium manganate, and lithium iron phosphate, nickel sulfide, copper sulfide, sulfur, iron oxide, and vanadium oxide.

The binder may include at least one material selected from the group consisting of a polyvinylidene fluoride-based binder such as polyvinylidene fluoride, a vinylidene fluoride/hexafluoropropylene copolymer, or a vinylidene fluoride/tetrafluoroethyline copolymer, a carboxymethyl cellulose-based binder, such as sodium-carboxymethylcellulose or, lithium-carboxymethyl cellulose, an acrylate-based binder such as polyacrylic acid, lithium-polyacrylic acid, acryl, polyacrylonitrile, polymethyl methacrylate, or and polybutyl acrylate, polyamidoimide, polytetrafluoroethylene, polyethylene oxide, polypyrrole, and lithium-nafion, and a styrene butadiene rubber-based polymer.

A conductive agent may include at least one material selected from the group consisting of carbon-based conductive agents such as carbon black, carbon fiber, carbon nanotubes, and graphite, conductive fibers such as metal fibers, metal powders such as fluorinated carbon powder, aluminum powder and nickel powder, a conductive whisker such as zinc oxide and potassium titanate. a conductive metal oxide such as and titanium oxide, and a conductive polymer such as a polyphenylene derivative.

The anode 120 may include an anode film 122 and a anode active material layer 124 applied on the anode film 122. Although FIG. 1 shows that the anode active material layer 124 is applied to one side of the anode film 122, the present disclosure is not limited to the present embodiment. In some embodiments, the anode active material layer 124 may be applied to both sides of the anode film 122.

The anode film 122 may include at least one metal selected from the group consisting of copper, stainless steel, nickel, titanium, etc. The anode active material layer 124 may include an anode active material, a binder, and a conductive agent.

The anode active material may include a material that is alloyable with lithium or capable of reversibly intercalating and deintercalating lithium. For example, the anode active material may include at least one material selected from the group consisting of metal, carbon-based material, metal oxide, and lithium metal nitride.

The metal is at least one material selected from the group consisting of lithium, silicon, magnesium, calcium, aluminum, germanium, tin, lead, arsenic, antimony, bismuth, silver, gold, zinc, cadmium, mercury, copper, iron, nickel, cobalt and indium.

The carbon-based material includes at least one material selected from the group consisting of graphite, graphitic carbon fiber, carbon nanotubes, coke, mesocarbon microbeads (MCMB), polyacene, pitch-based carbon fiber, and non-graphitizable carbon (hard carbon).

The metal oxide may include at least one selected from the group consisting of lithium titanium oxide, titanium oxide, molybdenum oxide, niobium oxide, iron oxide, tungsten oxide, tin oxide, amorphous tin composite oxide, silicon monoxide, cobalt oxide, and nickel oxide.

The binder and the conductive agent may be the same as the binder and the conductive agent included in the cathode active material layer, respectively.

The separator 130 may separate the cathode 110 and the anode 120 from each other and prevents a short circuit between the cathode 110 and the anode 120. The separator 130 may be formed by coating, for example, one substrate selected from the group consisting of polyethylene (PE), polystyrene (PS), polypropylene (PP), and a co-polymer of polyethylene (PE) and polypropylene (PP) with a polyvinylidene fluoride-hexafluoropropylene co-polymer (PVDF-HFP co-polymer). However, the manufacture method thereof is not limited thereto.

The separator 130 may include a coating layer 132 formed on at least one of both sides of the separator 130. Although FIG. 1 shows an example in which the coating layer 132 is formed on both sides of the separator 130, the present disclosure is not limited thereto, and the coating layer 132 may be formed on only one side of the separator 130.

The coating layer 132 may include boron nitride nanotubes (BNNT) to improve the lithium ions conductivity of the lithium ion secondary battery 10.

Boron nitride nanotubes (BNNT) are one-dimensional hexagonal nanotubes in which nitrogen (N) and boron (B) are alternately arranged, and as shown in FIG. 2, the ends may be open. Such boron nitride nanotubes (BNNT) have a length of about 5 μm to about 10 μm, and may have an aspect ratio of 20 to 6000, and the outer surface and internal space of the one-dimensional boron nitride nanotubes (BNNT) may be used as a movement path for lithium ions.

More specifically, electron deficiency (Lewis acid) at the boron center of boron nitride nanotubes (BNNT) may interact with electrolyte molecules of the oxygen-rich electrolyte 300 to induce desolvation of lithium ions, thereby improving lithium ion transport through the surface of boron nitride nanotubes (BNNT) and inside the tubes. That is, the Lewis acid interaction between the anion/solvent and the boron nitride nanotube (BNNT) may promote the dissociation of lithium ions and accelerate the transport of lithium ions, leading to a high lithium ion transport rate.

In addition, as shown in FIG. 3, at least some of the boron nitride nanotubes (BNNT) of the coating layer 132 are attached to form a certain angle with the surface of the separator 130, rather than being completely lying down on the surface of the separator 130. In an embodiment, the average surface roughness (rms) of the coating layer 132 may be about 50 nm to about 2 μm, and the angle formed between at least a portion of the boron nitride nanotube (BNNT) and the surface of the separator 130 may be about 1° to about 30°. As such, at least some of the boron nitride nanotubes (BNNT) are attached such that the same may form a certain angle with the surface of the separator 130, thereby acting as a passage through which lithium ions can move directionally between the cathode 110 and the anode 120. In this regard, the boron nitride nanotubes (BNNT) attached to form a certain angle with the surface of the separator 130 may be about 30% to about 70% of the total boron nitride nanotubes (BNNT).

In addition, the ionic conductivity of the separator 130 on which the coating layer 132 is formed, is not more than 1.7 mS/cm at 60° C. and at least 0.4 mS/cm at −10° C., so that excellent ionic conductivity can be maintained at high and low temperatures, and rapid performance degradation of the lithium ion secondary battery 10 can be minimized.

Additionally, when boron nitride nanotubes (BNNT) are attached on the surface of the separator 130, the tendency of the separator 130 to heat shrink when the separator 130 is heated may be reduced. Therefore, due to the formation of the coating layer 132 including boron nitride nanotubes (BNNT) on at least one of both sides of the separator 130, the ionic conductivity of the lithium ion secondary battery 10 may be increased and at the same time, the stability of the separator 130 may also be increased.

The case 200 may have various shapes and materials, depending on the type of lithium ion secondary battery 10. The lithium ion secondary battery 10 may be coin-shaped, square-shaped, pouch-shaped, or cylindrical, and accordingly, the case 200 may be rigid coin-shaped, square-shaped, or cylindrical, or flexible pouch-shaped.

The case 200 is filled with the electrolyte 300, and the electrode assembly 100 may be immersed in the electrolyte 300.

The electrolyte 300 may be a non-aqueous electrolyte containing lithium salt, an organic solvent, etc. However, the electrolyte 300 may include, but is not limited to, an aqueous electrolyte, a gel polymer electrolyte, etc.

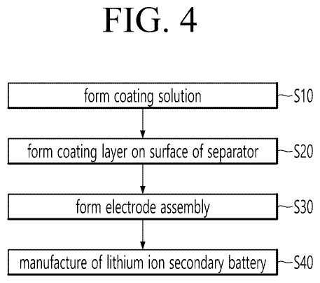

FIG. 4 is a flowchart schematically showing the manufacturing method of the lithium ion secondary battery of FIG. 1.

Referring to FIGS. 1 and 4 together, the method of manufacturing a lithium ion secondary battery 10 according to an embodiment of the present disclosure includes mixing boron nitride nanotubes (BNNT) with a solvent to form a coating solution (S10), forming the coating layer 132 by coating at least one of both sides of the separator 130 with the coating solution (S20), disposing the cathode 110 and the anode 120 respectively on both sides of the separator 130 on which the coating layer 132 is formed to form the electrode assembly 100 (S30), and placing the electrode assembly 100 in the case 200 and filling the case 200 with the electrolyte 300 to manufacture a lithium ion secondary battery 10 (S40).

The coating solution may be formed by dispersing boron nitride nanotubes (BNNT) in a solvent. Dispersion may be performed by ultrasonic dispersion, stirring, etc.

The solvent may be hydrophobic or hydrophilic. In the case of hydrophobicity, the solvent may include a nitrile-based solvent, an ether-based solvent, an ester-based solvent, etc., and the nitrile-based solvent may include, for example, acetonitrile.

In the case of hydrophilicity, the solvent may include acetic acid, acetylacetone, 2-aminoethanol, anisole, isopropyl alcohol, benzyl alcohol, 1-butanol, 2-butanol, 2-butanone, t-butyl alcohol, cyclohexanol, cyclohexanone, di-n-butyl phthalate, diethyl glycol, diglyme, dimethoxyethane, dimethylformamide, dimethyl phthalate, dimethyl sulfoxide, dioxane, ethanol, ether, ethyl acetate, ethyl acetoacetate, ethyl benzoate, ethylene glycol, glycerin, N-methyl-2-pyrrolidone, tetrahydrofuran, etc.

Boron nitride nanotubes (BNNT) may be included in the coating solution in the amount of about 0.01 wt % to about 10 wt %.

When boron nitride nanotubes (BNNT) are included in the amount of 0.01 wt % or more based on the total 100 wt % of the coating solution, when forming the coating layer 132 by spraying the coating solution on at least one side of the separator 130, lithium ionic conductivity of the separator 130 is increased and thermal stability thereof is improved, resulting in improvement in the performance and stability of the lithium ion secondary battery 10.

On the other hand, when the amount of boron nitride nanotubes (BNNT) is greater than 10 wt % based on the total 100 wt % of the electrolyte 300, agglomeration of boron nitride nanotubes (BNNT) occurs on the surface of the separator 130, causing the decrease in the charging performance and capacity of a lithium ion secondary battery

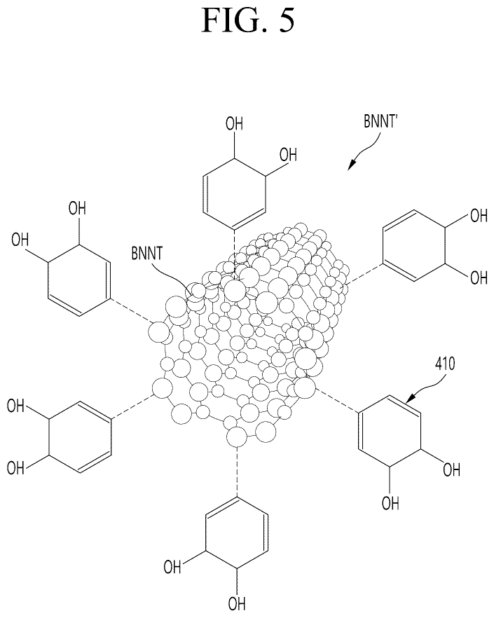

Meanwhile, as will be described later, the coating layer 132 may be formed by electrostatically spraying or mechanical spraying a coating solution. Therefore, boron nitride nanotubes (BNNT) need to be uniformly dispersed in the coating solution for forming the coating layer 132. However, boron nitride nanotubes (BNNT) generally have low dispersibility with respect to organic and aqueous solvents. Accordingly, when the surface of boron nitride nanotubes (BNNT) is treated to be hydrophilic or hydrophobic, the dispersibility of boron nitride nanotubes (BNNT) may be increased. This will be explained with reference to FIGS. 5 to 8.

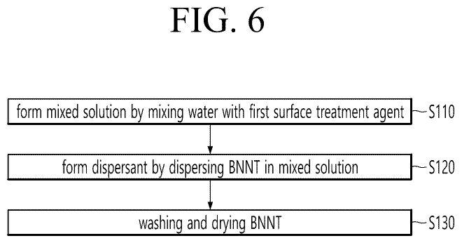

FIG. 5 is a perspective view schematically showing an example of boron nitride nanotubes included in the electrolyte of FIG. 1, and FIG. 6 is a flowchart schematically showing the surface treatment method of the boron nitride nanotube of FIG. 5.

FIG. 5 shows an example of surface-treated boron nitride nanotube (BNNT′). Referring to FIG. 5, a surface-treated boron nitride nanotube (BNNT′) may include a first layer 410 on at least a portion of the surface of the boron nitride nanotube (BNNT).

For example, the first layer 410 may include a hydroxy phenyl group to make the boron nitride nanotubes (BNNT) hydrophilic, so that the surface-treated boron nitride nanotube (BNNT′) may be well dispersed in a polar electrolyte.

For example, the first layer 410 includes a hydroxy phenyl group and may form a π bond with a boron nitride nanotube (BNNT). For example, the first layer 410 may include, as a polyphenol group, at least one of tannic acid, gallic acid, catechol, epigallocatechin, pyrogallol, hexahydroxydiphenic acid, ellagic acid, and chlorogenic acid.

The polyphenol group of the first layer 410 may be oxidized to a highly reactive quinone oligomer and attached on the surface of a boron nitride nanotube (BNNT), and due to the interaction between the catechol molecule of the polyphenol group and the boron nitride nanotubes (BNNT) through van der Waals bond and π-π stacking, the first layer 410 may be formed on the boron nitride nanotube (BNNT).

As such, the first layer 410 is formed on at least a portion of the surface of the boron nitride nanotube (BNNT), allowing hydroxyl groups to exist on the surface of the boron nitride nanotube (BNNT), thereby making the surface-treated boron nitride nanotube (BNNT′) to be hydrophilic. As a result, dispersibility of the boron nitride nanotube (BNNT) in a hydrophilic solvent may be improved.

As shown in FIG. 6, the method of forming the first layer 410 includes mixing water with a first surface treatment agent to form a mixed solution (S110), and dispersing boron nitride nanotubes (BNNT) in the mixed solution to form a dispersion (S120), and washing and drying boron nitride nanotubes (BNNT) (S130).

The first surface treatment agent is a material capable of forming the first layer 410 and may include a hydroxy phenyl group. For example, the first surface treatment agent may include, as a polyphenol group, at least one of tannic acid, gallic acid, catechol, epigallocatechin, pyrogallol, hexahydroxydiphenic acid, ellagic acid, and chlorogenic acid.

The first surface treatment agent may be included in an amount of about 0.1 wt % to about 0.2 wt % based on the entire mixed solution. When the amount of the first surface treatment agent in the mixed solution is less than 0.1 wt %, it is difficult to form the first layer 410 that renders boron nitride nanotubes (BNNT) hydrophilic. On the other hand, even when the amount of the first surface treatment agent is greater than 0.2 wt %, the surface treatment effect of boron nitride nanotubes (BNNT) is not continuously increased. Therefore, the amount of the first surface treatment agent may be about 0.1 wt % to about 0.2 wt % based on the entire mixed solution.

Next, boron nitride nanotubes (BNNT) are dispersed in the mixed solution. Dispersion may be performed by ultrasonic dispersion, stirring, etc.

In this regard, the dispersion may have slightly alkaline properties. Since the dispersion is slightly alkaline, the polyphenol group may be oxidized into a highly reactive quinone oligomer due to dissolved oxygen in the dispersion, and as a result, the same is attached on the surface of the boron nitride nanotube (BNNT), forming the first layer 410.

The pH of the dispersion may be adjusted by a base such as sodium hydroxide. In some embodiments, the pH of the dispersion may be about 8 to about 9. When the pH of the dispersion is less than 8 or greater than 9, it is difficult to form quinone oligomers, so the pH of the dispersion may be between about 8 and about 9.

The mixing ratio of the boron nitride nanotubes (BNNT) dispersed in the dispersion and the first surface treatment agent may be about 1:1 to about 1:0.1 in wt %. When the amount of boron nitride nanotubes (BNNT) dispersed in the dispersion exceeds 10 times that of the first surface treatment agent, it may be difficult to effectively form the first layer 410 on the surface of the boron nitride nanotubes (BNNT). On the other hand, when the amount of boron nitride nanotubes (BNNT) dispersed in the dispersion is less than 1 time that of the first surface treatment agent, the amount of the first surface treatment agent discarded during the subsequent washing process is rapidly increased.

After boron nitride nanotubes (BNNT) are dispersed in the mixed solution to form a dispersion, the boron nitride nanotubes (BNNT) on which the first layer 410 is formed are washed and dried.

In the washing process, the surface-treated boron nitride nanotube (BNNT′) are washed with water to remove remaining polyphenol groups. Next, only the surface-treated boron nitride nanotube (BNNT′) are collected through centrifugation or filtering, and then dried to obtain the powder of surface-treated boron nitride nanotube (BNNT′) to have hydrophilicity.

This method may be carried out at room temperature in atmospheric conditions. Therefore, according to the present disclosure, without creating a specific environment, the boron nitride nanotubes can be made to have hydrophilic by a simple method of dispersing the boron nitride nanotubes in a mixture of the first surface treatment agent and water. In addition, tannic acid and the like contained in the first layer are environmentally friendly substances derived from nature, and the surface-treated boron nitride nanotubes may not cause environmental pollution.

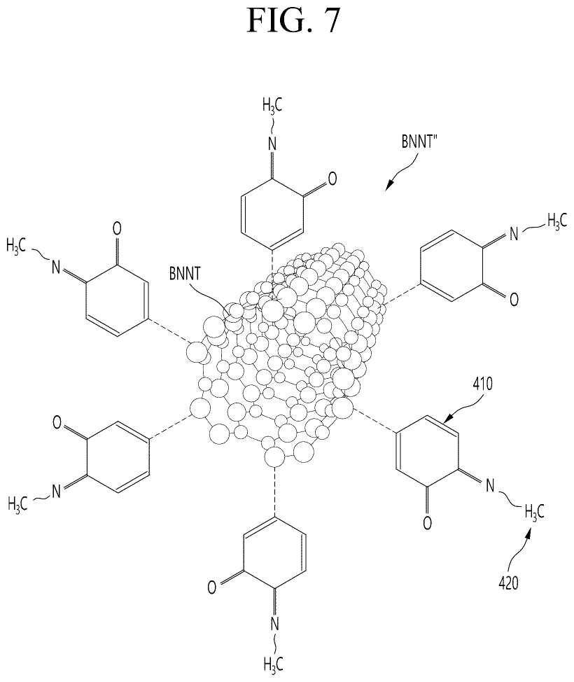

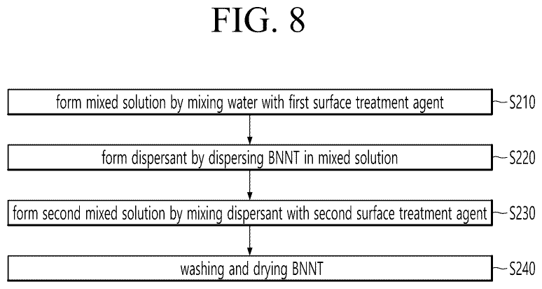

FIG. 7 is a perspective view schematically showing another example of boron nitride nanotubes included in the electrolyte of FIG. 1, and FIG. 8 is a flowchart schematically showing the surface treatment method of the boron nitride nanotube of FIG. 7.

FIG. 7 shows another example of surface-treated boron nitride nanotube (BNNT″). Referring to FIG. 7, a surface-treated boron nitride nanotube (BNNT″) may include a first layer 410 formed on at least a portion of the surface of the boron nitride nanotube (BNNT) and a second layer 420 on the first layer 410. That is, compared to the surface-treated boron nitride nanotube (BNNT′) of FIG. 5, due to the inclusion of the second layer 420, the boron nitride nanotube (BNNT) may have hydrophobicity.

The second layer 420 may be formed on the first layer 410. Since the first layer 410 is the same as shown and described in FIG. 5, the description will not be repeated.

The second layer 420 is a layer for rendering a boron nitride nanotube (BNNT) hydrophobic, and may include an amine group or a thiol group as a hydrocarbon group. For example, the second layer 420 may include at least one of alkyl amine, alkyl thiol, aryl amine, aryl thiol, benzyl amine, and benzyl thiol.

Meanwhile, the polyphenol group of the first layer 410 may be oxidized into a highly reactive quinone oligomer and attached on the surface of the boron nitride nanotube (BNNT), and the quinone structure attached in such a manner may anchor the primary amine group of the second layer 420 by a Michael addition mechanism. In some embodiments, the reaction between the amine or thiol of the second layer 420 and the hydroxyl group of the first layer 410 is the Michael addition of the amine or thiol of the second layer 420 to the hydroxyl group of the first layer 410. As a result of the addition reaction, the second layer 420 may be formed on the first layer 410.

When the second layer 420 is further included, the surface-treated boron nitride nanotube (BNNT″) become hydrophobic and may have excellent dispersibility in a hydrophobic solvent.

Meanwhile, the first layer 410 is omitted and the second layer 420 may not be formed directly on the surface of the boron nitride nanotube (BNNT). Therefore, in order to form the second layer 420 to render the boron nitride nanotube (BNNT) hydrophobic, the first layer 410 may be formed in advance.

As shown in FIG. 7, the method for forming the second layer 420 may include mixing water with a first surface treatment agent to form a first mixed solution (S210), adding boron nitride nanotubes (BNNT) to the first mixed solution to form a dispersion (S220), mixing a second surface treatment agent with the dispersion to form a second mixed solution (S230), and washing and drying the boron nitride nanotubes (BNNT) (S240).

The forming the first mixed solution (S210) and the forming the dispersion (S220) are the same as the forming the mixed solution of FIG. 6 (S110 of FIG. 6) and the forming the dispersion (S120 of FIG. 6). Therefore, the description will not be repeated, and only the differences between FIG. 5 and FIG. 6 will be described.

Referring to FIG. 8, after forming the dispersion, a second surface treatment agent is additionally mixed with the dispersion to form a second mixed solution (S230). The second surface treatment agent may include a material for rendering boron nitride nanotubes (BNNT) hydrophobic, for example, an amine group or a thiol group as a hydrocarbon group that may be Michael added to the hydroxyl group of the first layer 410.

In some embodiments, the second surface treatment agent may include at least one of alkyl amine, alkyl thiol, aryl amine, aryl thiol, benzyl amine, and benzyl thiol.

The mixing amount of the second surface treatment agent may be about 0.5 times to about 2 times the mixing amount of boron nitride nanotubes (BNNT). When the mixing amount of the second surface treatment agent is less than 0.5 times that of boron nitride nanotubes (BNNT), it is difficult to effectively form the second layer and boron nitride nanotubes (BNNT) may not be rendered to be hydrophobic, and when the mixing amount of the second surface treatment agent is greater than twice the mixing amount of boron nitride nanotubes (BNNT), the amount of the second surface treatment agent discarded during the subsequent washing process may be rapidly increased.

After boron nitride nanotubes (BNNT) are dispersed in the second mixed solution to form a dispersion, the boron nitride nanotubes on which the second layer is formed are washed and dried (S240).

In the washing process, the surface-treated boron nitride nanotubes (BNNT″) are sequentially washed with water and then ethanol to remove remaining polyphenol groups and hydrocarbon groups. Next, only the surface-treated boron nitride nanotube (BNNT″) are collected through centrifugation or filtering, and then dried to obtain the powder of surface-treated boron nitride nanotube (BNNT″) which is rendered to have hydrophobicity.

Meanwhile, in the case where, unlike this method, the second surface treatment agent is mixed with an organic solvent, for example, toluene and boron nitride nanotubes (BNNT) are dispersed therein, the second layer 420 was not be formed on the surface of the boron nitride nanotubes (BNNT) and thus boron nitride nanotubes (BNNT) were not able to be rendered hydrophobic. That is, to form the second layer 420, the first layer 410 may be previously formed on the surface of the boron nitride nanotube (BNNT) using a first surface treatment agent.

This method may be carried out at room temperature in atmospheric conditions. Therefore, according to the present disclosure, without creating a specific environment, the boron nitride nanotubes can be made to have hydrophobic by a simple method of dispersing boron nitride nanotubes (BNNT) in a mixture of the first surface treatment agent and water and then additionally mixing with the second surface treatment agent. In addition, according to this method, water is used as a dispersion medium in the process of surface-treating boron nitride nanotubes (BNNT) to make them hydrophobic. As a result, the issue of environmental pollution due to the use of organic solvents may not occur.

Referring again to FIG. 4, the prepared coating solution is coated on at least one surface of the separator 130 to form the coating layer 132 (S20).

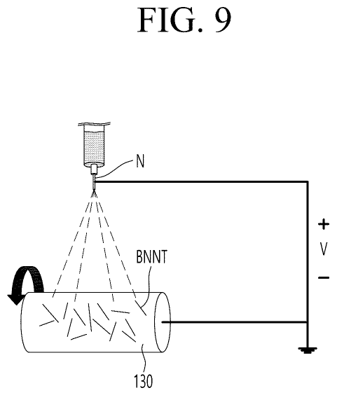

FIG. 9 is a diagram schematically showing an example of a method of forming a boron nitride nanotube coating layer on the separator of FIG. 1.

FIG. 9 schematically shows an electrostatic spraying method as an example of a method of forming the coating layer 132. Electrostatic spraying is a method of dividing a liquid into fine droplets using electric force and spraying the same. For example, the liquid passing through the nozzle (N) forms a Taylor Cone by electromagnetic force, and the liquid passes through a short liquid column section and splits due to the repulsive force between particles, thereby being sprayed in the form of fine droplets. In this regard, the fine droplets being sprayed are in a charged state. Accordingly, during electrostatic spraying, voltage is applied to the nozzle N, and an electrode body such as a drum may be in a grounded state.

Referring to FIG. 9, the separator 130 is located on an electrode body such as a drum, and the coating solution is electrostatically sprayed onto the separator 130 from a nozzle N provided with a hole having a diameter in micro units, thereby forming the coating layer 132. In this regard, the drum is in a grounded state and is formed in a cylindrical shape and rotatable.

FIG. 9 illustrates electrostatic spraying as an example of a method of forming the coating layer 132, but the present disclosure is not limited thereto. In some embodiments, the coating layer 132 may be formed by various methods such as mechanical spraying, air spray and ultrasonic spray.

In some embodiments, a material for forming the separator 130 may be sprayed on the rotating conveyor belt to form the separator 130 and then, a coating solution for forming the coating layer 132 may be sprayed on the separator 130 formed to continuously form the separator 130 and the coating layer 132. Here, the material for forming the separator 130 may be polyethylene (PE), polystyrene (PS), polypropylene (PP), polyvinylidene a fluoride-hexafluoropropylene copolymer, etc.

After spraying the coating solution, the result may be dried to remove the solvent therefrom to form the coating layer 132. Drying can be done by various methods such as vacuum drying, hot air drying, freeze drying, and spray drying.

Meanwhile, the coating layer 132 may be formed by repeating the electrostatic spraying multiple times. For example, the coating layer 132 may be formed by repeating the electrostatic spraying and drying 2 to 4 times. When electrostatic spraying is repeatedly performed multiple times to form the coating layer 132, the amount of boron nitride nanotubes included in the coating layer 132 is increased, and more boron nitride nanotubes are used as a movement path for lithium ions, thereby increasing the overall ionic conductivity.

Specifically, when the coating layer 132 is formed using a coating solution including 0.1 wt % of boron nitride nanotubes, the ionic conductivity of the separator 130 when the coating layer 132 is formed through one-time electrostatic spraying was 1.34 mS/cm; when the coating layer 132 was formed through electrostatic spraying twice, the ionic conductivity of the separator 130 was increased to 1.48 mS/cm; and when the coating layer 132 was formed by electrostatic spraying three times, the ionic conductivity of the ionic conductivity was increased to 1.78 mS/cm. However, when the number of electrostatic spraying exceeds 5 or more times, agglomeration of boron nitride nanotubes (BNNT) may occur on the surface of the separator 130, and the ionic conductivity of the separator 130 may be decreased.

Meanwhile, at least some of the boron nitride nanotubes (BNNT) included in the coating layer 132 may be attached to form a certain angle with the surface of the separator 130, rather than being completely lying down on the surface of the separator 130. In an embodiment, the average surface roughness (rms) of the coating layer 132 may be about 50 nm to about 2 μm, and the angle formed between at least a portion of the boron nitride nanotube (BNNT) and the surface of the separator 130 may be about 1° to about 30°. As such, at least some of the boron nitride nanotubes (BNNT) are attached such that the same may form a certain angle with the surface of the separator 130, thereby acting as a passage through which lithium ions can move directionally between the cathode 110 and the anode 120.

Next, the anode 120 and the cathode 110 are placed on both sides of the separator 130 on which the coating layer 132 is formed, respectively, to form the electrode assembly 100 (S30), and the electrode assembly 100 is placed in the case 200 and then, the case 200 is filled with an electrolyte to manufacture a lithium ion secondary battery 10 (S40).

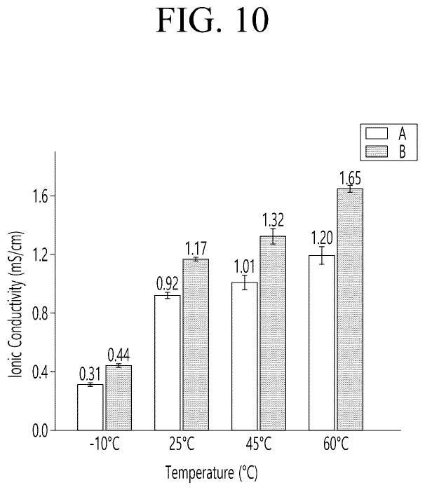

FIG. 10 is a diagram showing the results of measuring the lithium ionic conductivity of the separator.

Referring to FIG. 10, (A) shows the lithium ionic conductivity of the PE separator, and (B) shows the lithium ionic conductivity when a coating layer is formed on the surface of the PE separator according to the present disclosure.

Referring to (B) of FIG. 10, the coating layer was formed by electrostatically spraying a coating solution including 0.5 wt % of boron nitride nanotubes dispersed in isopropyl alcohol (IPA) on both sides of the PE separator, drying at a temperature of 40° C. for 24 hours to remove the solvent of the coating solution.

Ionic conductivity was measured by electrochemical impedance spectroscopy (EIS) using a stainless steel disk as a blocking electrode, and 1M LiPF₆ dispersed in a 1:1 mixture of EC and DMC was used as an electrolyte.

Referring to FIG. 10, in the case of (B) where a coating layer is formed, it can be seen that the lithium ionic conductivity is increased compared to (A), at room temperature (25° C.), at high temperature (60° C.), and at low temperature (−10° C.).

Specifically, in the case of (A), at low temperature (−10° C.), the ionic conductivity was 0.31 mS/cm, while in the case of (B) where a coating layer was formed, the ionic conductivity was 0.44 mS/cm, showing that the ionic conductivity was increased by about 42%. In addition, at high temperature (60° C.), in the case of (A), the ionic conductivity was 1.20 mS/cm, whereas in the case of (B) where a coating layer was formed, the ionic conductivity was 1.65 mS/cm, showing an increase in ionic conductivity of about 37.5%. Therefore, due to the formation of a coating layer including boron nitride nanotubes, rapid performance degradation of lithium ion secondary batteries at high and low temperatures can be prevented or minimized.

Additionally, when the temperature was raised from 45° C. to 60° C., the ionic conductivity of (A) was increased by 19%, while that of (B) was increased by 25%. This indicates that the thermal stability of the separator is improved due to the formation of a coating layer on the separator.

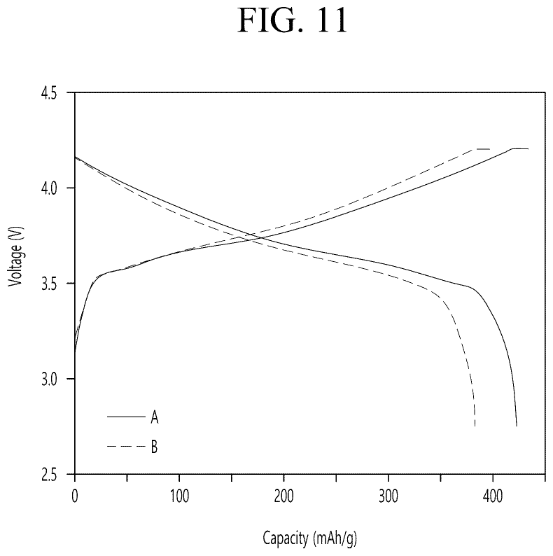

FIG. 11 is a graph showing the results of measuring the initial charge and discharging capacity of a lithium ion secondary battery.

FIG. 11 shows the results of precycling a lithium ion secondary battery including an NCM523 cathode and a graphite anode from 2.7 V to 4.2 V at a charge/discharge rate of 0.1 C. (A) of FIG. 11 includes the separator (A) of FIG. 10, and (B) of FIG. 11 includes the separator (B) of FIG. 10.

As can be seen in FIG. 11, in the case of (A), the discharging capacity was decreased to 380.4 mAh at the charging capacity of 383.6 mAh and the coulombic efficiency was measured at 99.19%, and in the case of (B) in which the separator including a coating layer including boron nitride nanotubes was used, the discharging capacity was decreased to 410.9 mAh at the charging capacity of 413.6 mAh, and the coulombic efficiency was measured at 99.34%. Therefore, it can be seen that due to the increase of the ionic conductivity caused by the formation of a coating layer in a separator, the efficiency of a lithium ion secondary battery is increased.

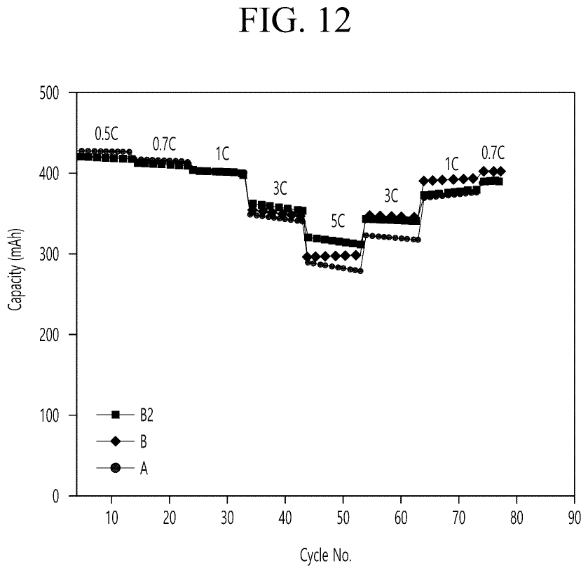

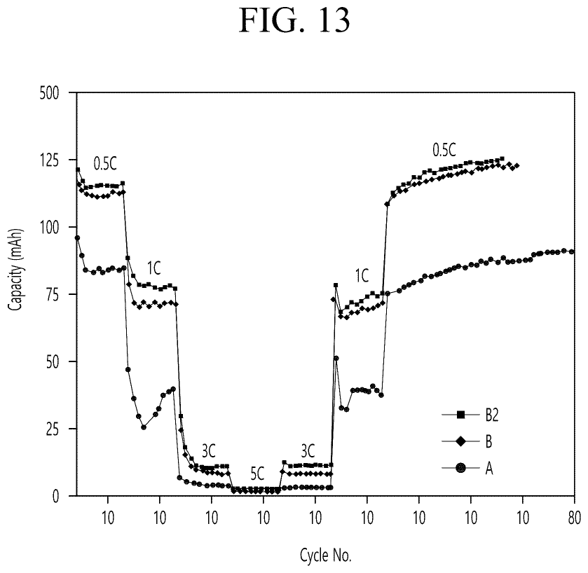

FIGS. 12 and 13 show the rate performance of a lithium ion secondary battery according to temperature and charge/discharge speed.

In FIGS. 12 and 13, (A) is the result of using the lithium ion secondary battery of (A) in FIG. 11, and (B) is the result of using the lithium ion secondary battery of (B) of FIG. 11. In addition, (B2) in FIGS. 12 and 13 shows the result of using a lithium ion secondary battery including a separator with a coating layer thereon including boron nitride nanotube prepared in the same manner as in (B) except that in forming the coating layer, a coating solution containing 0.7 wt % of boron nitride nanotubes was used.

FIGS. 12 and 13 show the capacity of a lithium ion secondary battery measured at different charging and discharging rates. Here, FIG. 12 shows the capacity measured at 25° C. and FIG. 13 shows the capacity measured at −10° C.

First, referring to FIG. 12, it can be seen that (B) and (B2) have better charging/discharging speed characteristics than (A) at 0.5 C, 0.7 C, 1 C, 3 C, and 5 C. In particular, referring to FIG. 13 showing the results measured at −10° C., it can be seen that (B) and (B2) have superior characteristics according to charge/discharge speed compared to (A) at 0.5 C, 1 C, and 3 C.

As can be seen from these results, when a coating layer including boron nitride nanotubes is formed on the separator, compared to the case where the coating layer is not formed, the characteristics according to the charge and discharge speed are improved not only at room temperature but also at low temperatures due to an increase in lithium ionic conductivity.

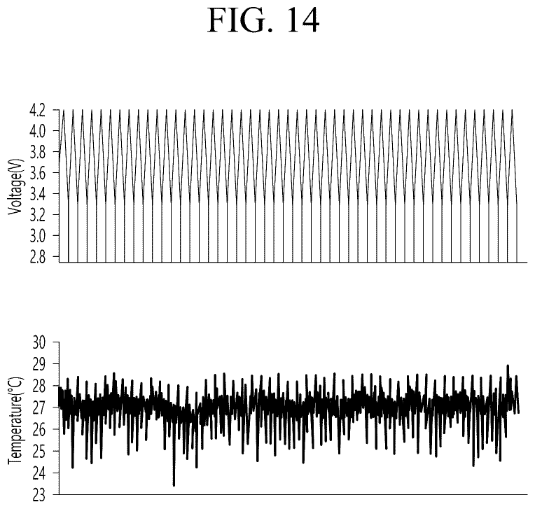

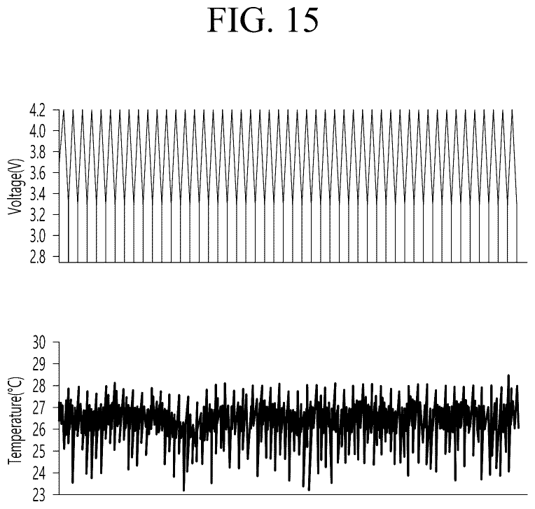

FIGS. 14 and 15 show the results of measuring the temperature of a lithium ion secondary battery during charging and discharging. FIG. 14 shows the result of the lithium ion secondary battery of (A) of FIG. 11, and FIG. 15 shows the result of using the lithium ion secondary battery of (B) of FIG. 11. In FIGS. 14 and 15, the temperature of the lithium ion secondary battery was measured during repeated charging and discharging at room temperature (25° C.) at a charge/discharge rate of 0.5.

Referring to FIGS. 14 and 15, it can be seen that (B), where a coating layer including boron nitride nanotubes is formed on the separator, has a lower average temperature than (A). In particular, the maximum temperature of (B) was 27.96° C., and (A) was measured at 28.85° C. Accordingly, it can be seen that when a coating layer including boron nitride nanotubes is formed on the separator, the heat dissipation characteristics of the lithium ion secondary battery are also improved. This may be due to the fact that boron nitride nanotubes are a material with very high thermal conductivity, and also have high lithium ionic conductivity, resulting in low internal resistance.

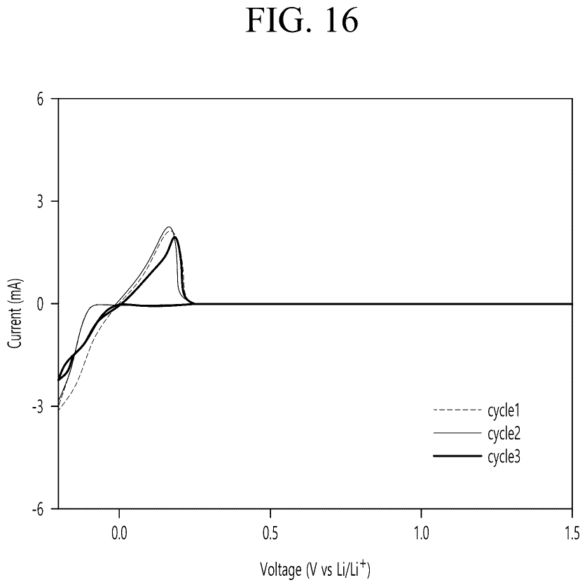

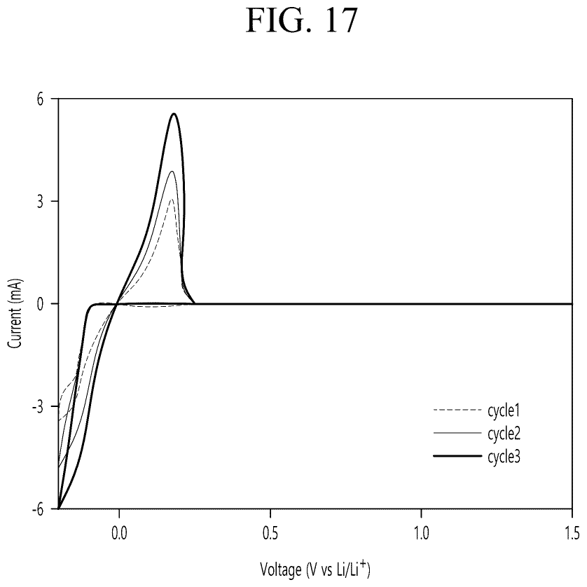

FIGS. 16 and 17 are graphs showing cyclic voltammetry (CV) test results of a lithium ion secondary battery. FIGS. 16 and 17 show results of a test to confirm the possibility of a chemical reaction between an electrode and an electrolyte that occurs during charging and discharging of a lithium ion secondary battery. That is, the test was performed to confirm the occurrence of a chemical reaction in a configuration with a separator between a lithium metal electrode and a stainless steel electrode.

FIG. 16 shows the result of the lithium ion secondary battery of (A) of FIG. 11, and FIG. 17 shows the result of using the lithium ion secondary battery of (B) of FIG. 11. In FIGS. 16 and 17, the scan rate was set to −0.2 V to 5 V and 0.1 mV/s.

Referring to FIGS. 16 and 17, FIGS. 16 and 17 have peaks at the same location, but FIG. 17 shows a larger current peak compared to FIG. 16, indicating a greater ionic conductivity.

In addition, as can be seen in FIG. 17, the results of the cyclic voltammetry (CV) test show that no significant peaks were generated during reduction less than 0 voltage and during oxidation more than 0 voltage. In other words, since no chemical reaction occurs between the lithium metal electrode and the stainless steel electrode, it can be seen that the lithium ion battery according to the present disclosure has electrochemical stability and can be implemented in practical battery applications.

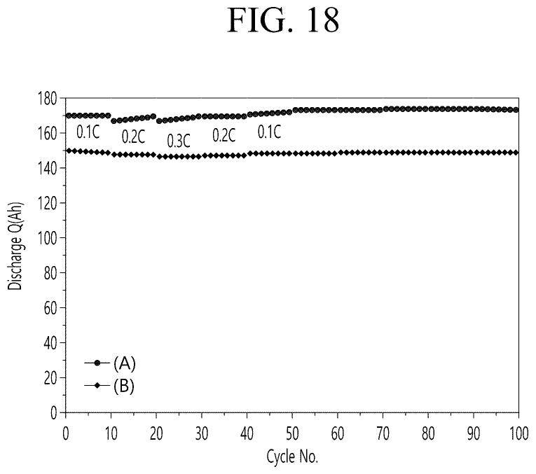

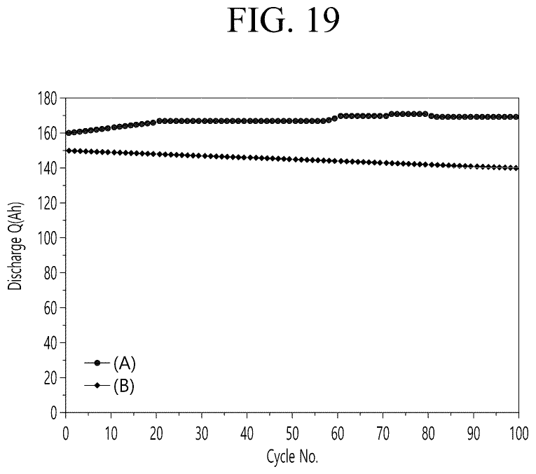

FIG. 18 is a diagram showing the characteristics (C-rate performance) according to the charge and discharge rate of a lithium ion secondary battery, and FIG. 19 is a diagram showing the cycle retention results of the lithium ion secondary battery of FIG. 18.

Referring to FIGS. 18 and 19, the lithium ion secondary battery used was type of a pouch and included an LFP cathode material, a graphite anode material, and LiPF₆ electrolyte, and a PE separator as the separator.

Referring to FIGS. 18 and 19, (A) corresponds to a case where the coating layer according to the present disclosure is not applied to the separator, and (B) corresponds to a case where a coating layer comprising boron nitride nanotubes is formed on the separator. The coating layer was formed in the same manner as in FIG. 10.

Referring to FIG. 18, it can be seen that the discharging capacity of (B) is greater than that of (A) at 0.1 C, 0.2 C, and 0.3 C. This is because lithium ionic conductivity was improved by forming a coating layer including boron nitride nanotubes on the surface of the separator.

In addition, FIG. 19 shows the discharging capacity when charging and discharging were repeatedly performed at a rate of 0.1C, and it can be seen that the discharging capacity of (B) in the case where a coating layer was formed on the surface of the separator was increased compared to (A) without a coating layer.

In other words, even in the case of secondary batteries using various cathode materials such as LFP rather than NCM type cathode materials, lithium ionic conductivity can be improved by forming a coating layer including boron nitride nanotubes on the surface of the separator, thereby improving the performance of the secondary battery.

According to embodiments of the present disclosure, the ionic conductivity of the lithium ion secondary battery may be increased, and the performance of the lithium ion secondary battery may be improved.

In addition, boron nitride nanotubes are attached on the surface of the separator, so that the tendency of the separator to shrink is reduced and the generated heat is efficiently dissipated, improving thermal stability. As a result, the safety of a secondary battery may be improved.

As such, the present disclosure has been described with reference to an embodiment shown in the drawings, but this is only an example, and those skilled in the art will understand that various modifications and variations of the embodiment can be made. Therefore, the true scope of technical protection of the present disclosure should be determined by the technical spirit of the attached patent claims.

What is claimed is:

1. A lithium ion secondary battery comprising:
an electrode assembly including an anode, a cathode, and a separator disposed between the anode and the cathode;
a case accommodating the electrode assembly; and
an electrolyte filling the case, wherein
the separator includes a coating layer on at least one of both sides of the separator, and
the coating layer includes boron nitride nanotubes.

2. The lithium ion secondary battery of claim 1, wherein
an ionic conductivity of the separator is 1.7 mS/cm or less at 60° C., and 0.4 mS/cm or more at −10° C.

3. The lithium ion secondary battery of claim 1, wherein
an average surface roughness of the coating layer is about 50 nm to about 2 μm.

4. The lithium ion secondary battery of claim 1, wherein
an aspect ratio of the boron nitride nanotubes is about 20 to about 6000.

5. The lithium ion secondary battery of claim 1, wherein
the boron nitride nanotubes are surface-treated to have hydrophilic or hydrophobic properties.

6. The lithium ion secondary battery of claim 5, wherein
the boron nitride nanotubes which are surface-treated further include a first layer located on at least a portion of each of the boron nitride nanotubes,
the first layer includes a hydroxy phenyl group and forms a π bond with the boron nitride nanotubes.

7. The lithium ion secondary battery of claim 6, wherein
the boron nitride nanotubes which are surface-treated, have hydrophilic properties.

8. The lithium ion secondary battery of claim 6, wherein
the boron nitride nanotubes which are surface-treated further include a second layer on the first layer, and
the second layer includes an amine group or a thiol group as a hydrocarbon group, and the boron nitride nanotubes which are surface-treated have the hydrophobicity.

9. The lithium ion secondary battery of claim 1, wherein
at least some of the boron nitride nanotubes are attached to a surface of the separator at an angle of about 1° to about 30°.

10. A method of manufacturing a lithium ion secondary battery comprising:
mixing boron nitride nanotubes with a solvent to form a coating solution;
forming a coating layer by coating at least one of both sides of a separator with the coating solution;
forming an electrode assembly by placing an anode and a cathode respectively on both sides of the separator on which the coating layer is formed; and
placing the electrode assembly in a case and filling the case with an electrolyte.

11. The method of claim 10, wherein
the coating layer is formed by coating at least one of both sides of the separator with the coating solution via electrostatic spraying or mechanical spraying.

12. The method of claim 10, wherein
after forming the coating layer, the method further comprises drying the coating layer.

13. The method of claim 10, wherein
the coating solution comprises about 0.01 wt % to about 10 wt % of the boron nitride nanotubes.

14. The method of claim 10, wherein
the boron nitride nanotubes are surface-treated to have hydrophilic or hydrophobic properties.

15. The method of claim 10, wherein
an average surface roughness of the coating layer is about 50 nm to about 2 μm.
